(19) United States
(12) Patent Application Publication
(10) Pub. No.: US 2006/0229839 A1
(43) Pub. Date: Oct. 12, 2006

(54) Temperature sensing and monitoring technique for integrated circuit devices

(75) Inventor: Douglas B. Butler, Colorado Springs, CO (US)

Correspondence Address: HOGAN & HARTSON LLP, ONE TABOR CENTER, SUITE 1500, 1200 SEVENTEENTH ST, DENVER, CO, 80202, US

(73) Assignees: United Memories, Inc. Colorado Springs; Colorado Sony Corporation Tokyo

(21) Appl. No.: 11/092,175

(22) Filed: Mar. 29, 2005

(51) Int. Cl. G01K 1/00; G01K 3/00

(52) U.S. Cl. 702/130

(57) ABSTRACT

A temperature sensing and monitoring technique for integrated circuit devices, particularly dynamic random access memory (DRAM), which incorporates the comparison of a voltage inversely proportional to temperature to a voltage proportional to temperature thereby increasing the differential voltage vs. temperature. In a representative embodiment disclosed herein, these two voltages are designed to be equal at a given temperature and a comparison circuit produces a signal that changes from a logic level “high” to a logic level “low” at that given temperature. An additional transistor in each trip point current path forces the gate-to-source and drain-to-source voltage of current mirror transistors to be equal at the temperature trip points.

### BACKGROUND OF THE INVENTION

The present invention relates, in general, to the field of integrated circuit devices. More particularly, the present invention relates to a temperature sensing and monitoring technique for integrated circuit devices, particularly dynamic random access memories (DRAM).

Among the advantages of DRAMs over static random access memory (SRAM) and other integrated circuit data storage technologies is that their structure is very simple in that each cell typically comprises but a single small capacitor and an associated pass transistor. However, since these capacitors are made very small to provide maximum memory density and they can, under the best of circumstances, only hold a charge for a short period of time, they must be continually refreshed.

In essence, the circuitry to effectuate this refresh operation then serves to effectively read the contents of every cell in a DRAM array and refresh each one with a fresh “charge” before the charge leaks off and the data state is lost. In general, this “refreshing” is done by reading and restoring every “row” in the memory array whereby the process of reading and restoring the contents of each memory cell capacitor re-establishes the charge, and hence, the data state.

Another aspect of DRAM memory, whether stand-alone or embedded is that the frequency with which the cell contents must be refreshed is a function of device temperature. At lower operating temperatures, the memory need not be refreshed as frequently as at higher temperatures. Since this refresh operation adds to the overall latency in memory accesses, the ability to accurately sense the then current operating temperature and adjust the refresh of the memory to the lowest possible rate is highly desirable given the need for ever quicker “reads” and “writes” to the memory.

Conventional temperature sensing techniques for integrated circuit devices generally compare a constant voltage (or current) to a voltage (or current) that is proportional to temperature. Moreover, conventional techniques generally depend on current mirror transistors having a drain-to-source current that is essentially independent of the drain-to-source voltage. Implementations of specific temperature sensing techniques for certain integrated circuit devices are described, for example, in U.S. Pat. No. 6,157,244 issuing Dec. 5, 2000 for: “Power Supply Independent Temperature Sensor” and U.S. Pat. No. 6,531,911 issuing Mar. 11, 2003 for: “low-Power Band-Gap Reference and Temperature Sensor Circuit”.

### SUMMARY OF THE INVENTION

The present invention discloses a temperature sensing and monitoring technique for integrated circuit devices incorporating the comparison of a voltage inversely proportional to temperature to a voltage proportional to temperature thereby increasing the differential voltage vs. temperature. These two voltages are designed to be equal at a given temperature and a comparison circuit produces a signal that changes from a logic level “high” to a logic level “low” at that given temperature. The inclusion of an additional transistor in each trip point current path forces the gate-to-source and drain-to-source voltage of current mirror transistors to be equal at the temperature trip points.

Particularly disclosed herein is a temperature sensing method for an integrated circuit device comprising: establishing a first voltage which is inversely proportional to a temperature of the device; also establishing a second voltage which is directly proportional to the temperature of the device; comparing the first and second voltages; and producing an output signal when said first and second voltages are substantially equal.

Further disclosed herein is an integrated circuit device comprising a first circuit for establishing a first voltage inversely proportional to a temperature of the device; an associated circuit for establishing a second voltage directly proportional to the temperature; and a comparator coupled to receive the first and second voltages, the comparator producing an output signal having a first state thereof when the first voltage is lower than the second voltage and a second state when the first voltage is higher than the second voltage.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIGS. 1A and 1B are schematic illustration of a representative embodiment of a temperature monitor circuit in accordance with the technique of the present invention;

FIG. 2 is a schematic illustration of a representative embodiment of a comparator circuit for use in conjunction with the temperature monitor of the preceding figures;

FIG. 3 illustrates the interconnection of the temperature monitor circuit of FIGS. 1A and 1B with a number of comparator circuits of FIG. 2 in accordance with a particular representative system of the present invention; and

FIG. 4 is a graphical illustration of simulations performed on the temperature monitor of FIGS. 1A and 1B plotting voltage with respect to temperature.

### DESCRIPTION OF A REPRESENTATIVE EMBODIMENT

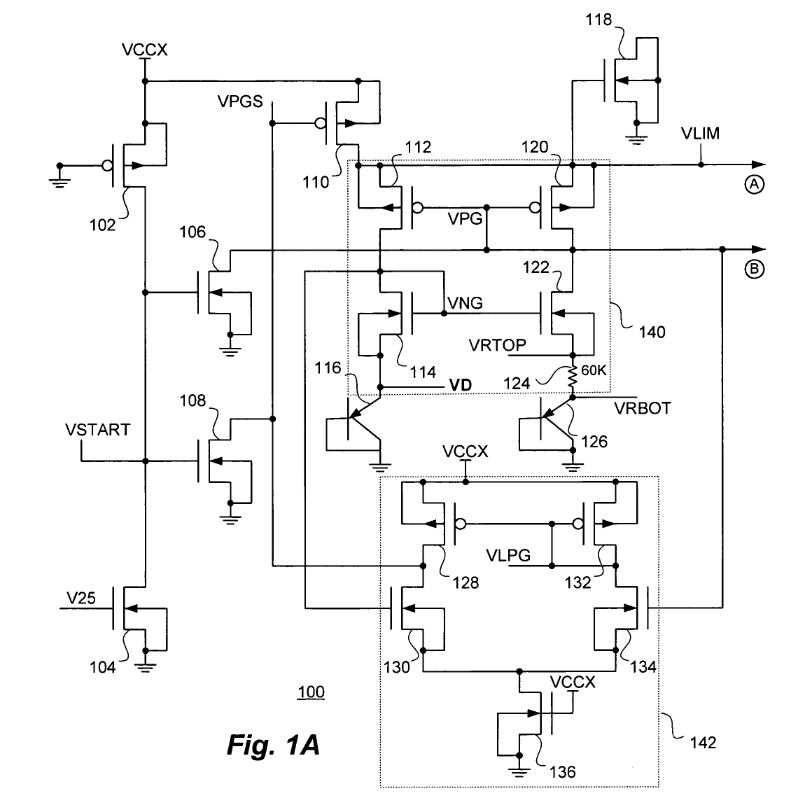

With reference now to FIGS. 1A and 1B, a schematic illustration of a representative embodiment of a temperature monitor circuit 100 in accordance with the technique of the present invention is shown. With specific reference to FIG. 1A in particular, the temperature monitor circuit 100 comprises a P-channel transistor 102 which has its gate connected to circuit ground (VS) and its source connected to a voltage source (VCCX). The drain of transistor 102 is connected to the drain of N-channel transistor 104 which has its source connected to circuit ground and its gate connected to receive a V25 signal. The common connected drains of transistors 102 and 104 are coupled to a node at which a start voltage (VSTART) signal is taken, as shown.

The gate terminals of N-channel transistors 106 and 108 are also coupled to the VSTART node as shown. The source terminals of transistors 106 and 108 are connected to circuit ground. A P-channel transistor 110 has its source terminal connected to VCCX and its gate terminal connected to the drain terminal of transistor 108. The drain terminal of transistor 110 is coupled to the source terminal of P-channel transistor 112 as well as to a node (line “A”) at which a voltage VLIM is taken. The drain terminal of transistor 112 is connected to the drain terminal of N-channel transistor 114, which has its source terminal connected to the emitter of PNP bipolar transistor 116 which has its base and collector terminals both connected to circuit ground. The drain terminal of transistor 114 is connected to its gate at node VNG and the voltage VD is taken at its source terminal. A capacitor connected N-channel transistor 118 has its gate connected to node VLIM and its drain and source terminals connected together at circuit ground.

A P-channel transistor 120 has its source terminal connected to node VLIM and its gate terminal connected to the gate terminal of transistor 112 at node VPG which is, in turn connected to the drain terminal of transistor 106 (line “B”). The drain terminal of transistor 120 is also connected to its gate terminal at line “B” as well as being connected to the drain terminal of N-channel transistor 122 which has its gate terminal connected to the gate and drain terminal of transistor 114 at node VNG. The source terminal of transistor 122 at node VRTOP is coupled through a resistor 124 (which in the embodiment shown may have a resistance of substantially 60K ohms) to the emitter terminal of another PNP bipolar transistor 126 (node VRBOT) which has its base and collector terminals also connected to circuit ground. In the embodiment illustrated, bipolar transistor 126 is constructed to be substantially ten times as large as corresponding bipolar transistor 116.

A P-channel transistor 128 has its source terminal connected to VCCX and its drain terminal connected to a node VPGS at the gate terminal of transistor 110 and the drain terminal of transistor 108. The drain terminal of N-channel transistor 130 is also connected to the drain terminal of transistor 128 while its gate terminal is connected to node VNG at the drain of transistor 114. The source terminal of transistor 130 is connected to the drain terminal of N-channel transistor 136 which has its source terminal connected to circuit ground and its gate terminal connected to VCCX.

In like manner, P-channel transistor 132 has its source terminal connected to VCCX and its gate terminal connected to its drain and the gate of transistor 128 at node VLPG. The drain terminal of transistor 132 is connected to the drain terminal of N-channel transistor 134 which has its source terminal also connected to the drain of transistor 136. The gate terminal of transistor 134 is connected to node VPG as also indicated as line “B”.

In essence, the interconnected transistors 112, 114, 120 and 122 comprise the voltage current mirror 140, with each device having a width-to-length ratio of substantially 2.0μ/2.0μ. The transistors 128, 130, 132, 134 and 136 comprise a differential amplifier 142, with all devices having a width-to-length ratio of substantially 4.0μ/0.4μ except for transistor 136 which may have a width-to-length ratio of substantially 0.5μ/50.0μ. The differential amplifier 142 functions to limit the voltage at VLIM to a level that results in VPG voltage being essentially equal to VNG.

Transistors 106 and 108 may have a width-to-length ratio of substantially 2.0μ/20.0μ, transistor 102 a width-to-length ratio of substantially 0.5μ/10.0μ, transistor 104 a width-to-length ratio of substantially 10.0μ/0.4μ, transistor 110 a width-to-length ratio of substantially 2.4μ/0.96μ while capacitor connected transistor 118 may have a width-to-length ratio of substantially 500.0μ/6.0μ.

With particular reference now to FIG. 1B, additional components of the temperature monitor circuit 100 are shown as connected to node VLIM (line “A”) and node VPG (line “B”). A capacitor coupled N-channel transistor 150 has its gate connected to node VLIM and its source and drain terminals connected together at circuit ground. A P-channel transistor 152 has its source terminal connected to node VLIM and its gate terminal connected to node VPG. The drain terminal of transistor 152 is connected to the common-connected drain and gate terminals of N-channel 154 which has its source terminal (node V25) coupled to circuit ground through a resistor 156. In the representative embodiment illustrated, resistor 156 may have a value of substantially 618K ohms.

Similarly, a P-channel transistor 158 has its source terminal connected to node VLIM and its gate terminal connected to node VPG. The drain terminal of transistor 158 is connected to the common-connected drain and gate terminals of N-channel 160 which has its source terminal (node V50) coupled to circuit ground through a resistor 162. In the representative embodiment illustrated, resistor 162 may have a value of substantially 522K ohms. Additionally, and in like manner, a P-channel transistor 164 has its source terminal connected to node VLIM and its gate terminal connected to node VPG. The drain terminal of transistor 164 is connected to the common-connected drain and gate terminals of N-channel 166 which has its source terminal (node V75) coupled to circuit ground through a resistor 168.

Also, in the representative embodiment illustrated, resistor 168 may have a value of substantially 438K ohms and the transistors 152, 154, 158, 160, 164 and 166 a width-to-length ratio of substantially 2.0μ/2.0μ. These latter devices are matched with the devices of the voltage current mirror 140 (FIG. 1A) and have the same voltage drain-to-source (V_{DS}) and voltage gate-to-source (V_{GS}) characteristics. Capacitor connected transistor 150 may have a width-to-length ratio of substantially 500.0μ/6.0μ. It should be noted that the resistance values of the resistors 156, 162 and 168 may be made programmable by trimming. Alternatively, the value of resistor 124 (FIG. 1A) may also be likewise made programmable by trimming.

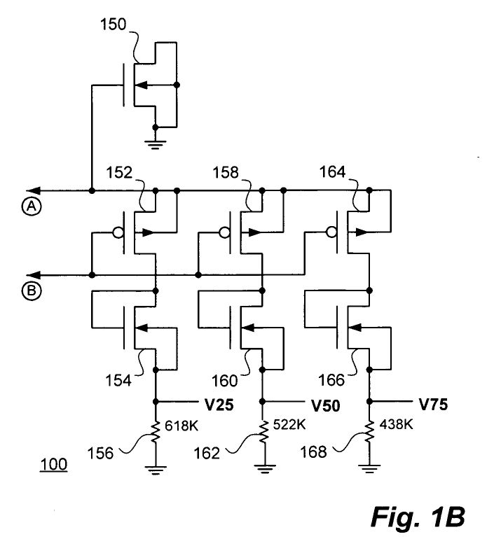

With reference additionally now to FIG. 2, a schematic illustration of a representative embodiment of a comparator circuit 200 for use in conjunction with the temperature monitor of the preceding figures is shown. The comparator circuit 200 comprises series connected P-channel transistor 202 and N-channel transistor 204 in parallel with P-channel transistor 206 and N-channel transistor 208. The source terminals of transistors 202 and 206 are connected to VCC while their respective gate terminals are common connected to the drain of transistor 202 at node DAPG. The source terminals of transistors 204 and 208 are connected to the drain terminal of N-channel transistor 210 at node DAB. The gate terminal of transistor 210 is connected to VCC while its source terminal is connected to circuit ground. The gate terminal of transistor 204 receives a VD signal while the gate terminal of transistor 208 receives a VIN signal of one of V25, V50 or V75 as will be more fully described hereinafter.

The DAO node intermediate transistors 206 and 208 is connected to the input of a first complementary metal oxide semiconductor (CMOS) inverter comprising series connected P-channel transistor 212 and N-channel transistor 215 connected between VCC and circuit ground. Output of this inverter is connected to the input of another inverter comprising similarly connected P-channel transistor 216 and N-channel transistor 218. The output of this second inverter is then applied through two more series connected inverters 220 and 222 to be provided as a signal VOUT as one of VT1, VT2 or VT3 depending on the input signal VIN. Stated another way, the comparator circuit 200 is operative to compare the voltage VD (which is inversely proportional to temperature) to a selected one of the voltages V25, V50 or V75 at node VIN (which voltages are proportional to temperature) to produce a signal VOUT that changes from a logic level “high” to a logic level “low” at that given temperature.

In the embodiment of the comparator circuit 200 illustrated, transistors 202 and 206 may have a width-to-length ratio of substantially 4.0μ/0.4μ, transistors 204 and 208 a width-to-length ratio of substantially 2.0μ/0.4μ, transistor 210 a width-to-length ratio of substantially 0.5μ/25.0μ, transistors 212 and 216 a width-to-length ratio of substantially 0.5μ/10.0μ while transistors 214 and 218 may have a width-to-length ratio of substantially 0.5μ/20.0μ.

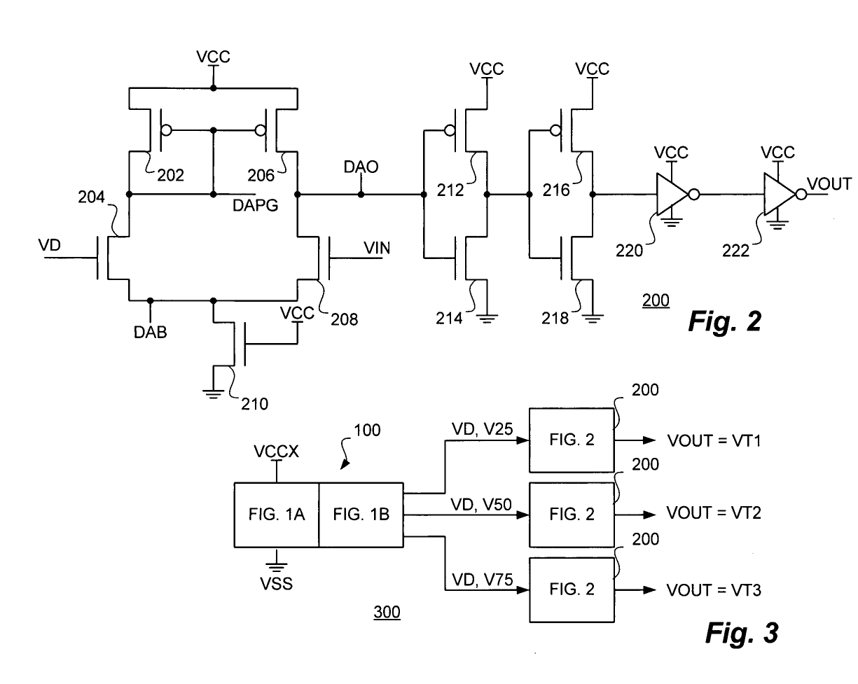

With reference additionally now to FIG. 3, the interconnection of the temperature monitor circuit 100 of FIGS. 1A and 1B with a number of comparator circuits 200 of FIG. 2 is shown in accordance with a particular representative embodiment of the present invention as system 300. As can be seen, three separate comparator circuits 200 are employed with a single temperature monitor circuit 100. A first of the comparator circuits 200 is coupled to receive the VD and V25 outputs of the temperature monitor circuit 100 to produce a VOUT signal of VT1. Similarly, a second of the comparator circuits 200 is coupled to receive the VD and V50 outputs of the temperature monitor circuit 100 to produce a VOUT signal of VT2 while the third comparator circuit is coupled to receive the VD and V75 outputs of the temperature monitor circuit 100 to produce a VOUT signal of VT3.

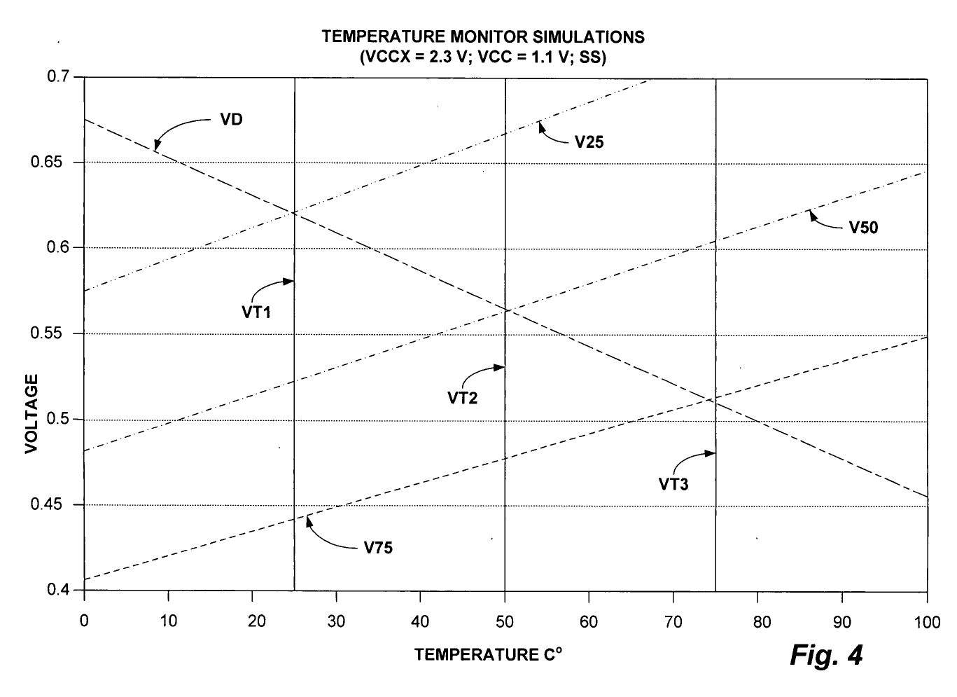

With reference additionally now to FIG. 4, a graphical illustration of simulations performed on the temperature monitor of FIGS. 1A and 1B is shown plotting voltage with respect to temperature. As is evident, the temperature monitor circuit 100 (FIGS. 1A and 1B) in conjunction with the comparator circuits 200 (FIG. 2) forming the system 300 (FIG. 3) results in the comparison of a voltage (VD) which is inversely proportional to temperature to a voltage (e.g. V25, V50 and V75) which is proportional to temperature thereby increasing the differential voltage vs. temperature. These two voltages are designed to be equal at a given temperature as indicated wherein VD=V25 at 25° C.; VD=V50 at 50° C. and VD=V75 at 75° C. In response, the associated comparator circuits 200 produce signals that change VT1, VT2 and VT3 from a logic level “high” to a logic level “low” at 25° C., 50° C. and 75° C. respectively.

At 25° C., the voltage V25 equals the voltage at VD. This is true because the total voltage dropped across transistors 112 and 114 is equal to the voltage dropped across transistors 152 and 154. Since the voltage on the gate of transistor 112 is equal to the voltage on the gate of transistor 152, the current through transistors 112 and 152 will be equal causing the gate of transistor 154 to bias to the same voltage as the gate of transistor 114. At this point, transistor 112 and transistor 152 are identically biased as are transistors 114 and 154. Analogous conditions are true at 50° C. and 75° C. for V50 and V75 respectively and their associated transistors.

While there have been described above the principles of the present invention in conjunction with specific circuitry and voltage vs. temperature points, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

What is claimed is:

1. A temperature sensing method for an integrated circuit device comprising:
establishing a first voltage which is inversely proportional to a temperature of said device;
also establishing a second voltage which is directly proportional to said temperature of said device;
comparing said first and second voltages; and
producing an output signal change when said first and second voltages are substantially equal.

2. The method of claim 1 wherein said step of establishing said first voltage comprises:
providing a first predetermined resistance in a current path of a current mirror circuit; and
developing said first voltage in conjunction with said first predetermined resistance.

3. The method of claim 2 wherein said step of also establishing said second voltage comprises:
providing a second predetermined resistance in an analogous current path; and
developing said second voltage in conjunction with said second predetermined resistance.

4. The method of claim 1 wherein said step of comparing said first and second voltages comprises:
providing said first and second voltages as inputs to a differential amplifier.

5. The method of claim 4 wherein said step of producing an output signal comprises:
producing a logic signal having a first state thereof when said first and second voltages are not equal; and
producing said logic signal with a second opposite state thereof when said first and second voltages are equal.

6. The method of claim 2 wherein said step of providing said first predetermined resistance is carried out by trimming an on-chip resistor.

7. The method of claim 3 wherein said step of providing said second predetermined resistance is carried out by trimming an on-chip resistor.

8. An integrated circuit device comprising:
means for establishing a first voltage which is inversely proportional to a temperature of said device;
means for also establishing a second voltage which is directly proportional to said temperature of said device;
means for comparing said first and second voltages; and
means for producing an output signal change when said first and second voltages are substantially equal.

9. The integrated circuit device of claim 8 wherein said means for establishing said first voltage comprises:
means for providing a first predetermined resistance in a current path of a current mirror circuit; and
means for developing said first voltage in conjunction with said first predetermined resistance.

10. The integrated circuit device of claim 9 wherein said means for also establishing said second voltage comprises:
means for providing a second predetermined resistance in an analogous current path; and
means for developing said second voltage in conjunction with said second predetermined resistance.

11. The integrated circuit device of claim 8 wherein said means for comparing said first and second voltages comprises:
means for providing said first and second voltages as inputs to a differential amplifier.

12. The integrated circuit device of claim 11 wherein said means for producing an output signal comprises:
means for producing a logic signal having a first state thereof when said first and second voltages are not equal; and
means for producing said logic signal with a second opposite state thereof when said first and second voltages are equal.

13. An integrated circuit device comprising:
a first circuit for establishing a first voltage inversely proportional to a temperature of said device;
an associated circuit for establishing a second voltage directly proportional to said temperature; and
a comparator coupled to receive said first and second voltages, said comparator producing an output signal having a first state thereof when said first and second voltages are substantially equal.

14. The integrated circuit device of claim 13 wherein said first circuit comprises a current mirror circuit.

15. The integrated circuit device of claim 14 wherein said current mirror circuit further comprises a first predetermined resistance in a current path thereof for establishing said first voltage.

16. The integrated circuit device of claim 15 further comprising a differential amplifier coupled to said current mirror circuit.

17. The integrated circuit device of claim 15 wherein said associated circuit comprises an analogous current path having a second predetermined resistance therein for establishing said second voltage.

18. The integrated circuit device of claim 13 wherein said comparator comprises a differential amplifier coupled to receive said first and second voltages.

19. The integrated circuit device of claim 15 whereby said first predetermined resistance is established by trimming.

20. The integrated circuit device of claim 17 whereby said second predetermined resistance is established by trimming.

21. The integrated circuit device of claim 13 wherein said first and associated circuits comprise first and second current paths comprising MOS transistors.

22. The integrated circuit device of claim 21 wherein said MOS transistors of said first and second current paths have substantially equivalent dimensions.

23. The integrated circuit device of claim 21 wherein said MOS transistors of said first and second current paths have substantially equivalent gate-to-source and drain-to-source voltage characteristics.

24. The integrated circuit device of claim 13 wherein said comparator is further operative to produce said output signal having a second opposite state thereof when said first and second voltages are not substantially equal.

25. An integrated circuit device comprising:
means for establishing a first voltage which is inversely proportional to a temperature of said device; and
means for also establishing a second voltage which is proportional to said temperature of said device
wherein said means for establishing said first voltage and said means for also establishing said second voltage utilize substantially identical transistors biased at substantially identical voltages at said temperature at which said first voltage and said second voltage are substantially equal.

26. The integrated circuit device of claim 25 wherein said substantially identical transistors comprise MOS transistors.

27. The integrated circuit device of claim 25 wherein said means for establishing said first voltage and said means for also establishing said second voltage comprise a respective pair of MOS transistors.

28. The integrated circuit device of claim 27 wherein said each of said respective pairs of MOS transistors comprise series coupled P-channel and N-channel transistors.

29. The integrated circuit device of claim 25 wherein said means for establishing said first voltage further comprises an additional transistor coupled in series therewith.

30. The integrated circuit device of claim 29 wherein said additional transistor comprises a bipolar transistor.

31. The integrated circuit device of claim 20 wherein said bipolar transistor comprises a PNP transistor.

32. A temperature sensing method for an integrated circuit device comprising:
establishing a first voltage which is inversely proportional to a temperature of said device;
also establishing a second voltage which is proportional to said temperature of said device; and
comparing said first and second voltages.

33. The method of claim 32 wherein said step for establishing said first voltage and said step for also establishing said second voltage is carried out by:
providing substantially identical transistors; and
biasing said substantially identical transistors at substantially identical voltages at said temperature at which said first voltage and said second voltage are substantially equal.

34. The method of claim 33 wherein said step of providing substantially identical transistors is carried out by MOS transistors.

35. The method of claim 32 wherein said step of establishing said first voltage and said step of also establishing said second voltage is carried out by respective pairs of MOS transistors.

36. The method of claim 32 wherein said step of establishing said first voltage further comprises:
providing an additional transistor coupled in series a respective pair of said MOS transistors.

37. The method of claim 36 wherein said step of providing an additional transistor is carried out by a bipolar transistor.

38. The method of claim 32 wherein said step of comparing said first and second voltages is carried out by means of a comparator.
